(19) United States
(12) Patent Application Publication
(10) Pub. No.: US 2025/0299478 A1
(43) Pub. Date: Sep. 25, 2025

(54) MONOCULAR CAMERA TIME ESTIMATION

(71) Applicant: Regents of the University of Minnesota, Minneapolis, MN (US)

(72) Inventors: Rajesh Rajamani, St. Paul, MN (US); Hamidreza Alai, Mineapolis, MN (US)

(21) Appl. No.: 19/085,322

(22) Filed: Mar. 20, 2025

Related U.S. Application Data
(60) Provisional application No. 63/567,650, filed on Mar. 20, 2024.

(51) Int. Cl. G06V 10/82; G06T 3/40; G06T 7/215; G06T 7/50; G06T 7/80; G06V 20/54; G06V 20/58

(52) U.S. Cl. CPC G06V 10/82; G06T 3/40; G06T 7/215; G06T 7/50; G06T 7/80; G06V 20/54; G06V 20/58; G06T 2207/20084

(57) ABSTRACT

In general, disclosed herein are systems and methods of using a monocular camera to determine an estimated time from encounter between an object a region of interest, including receiving an image from a camera, identifying an object from the image, calculating a scaled distance between the object and the region of interest based on the image, calculating a scaled velocity based on the scaled distance, and calculating an estimated time from encounter until the object will encounter the region of interest based on the scaled distance and the scaled velocity.

### CROSS-REFERENCE TO REPLACED APPLICATION

This application claims the benefit of U.S. Provisional Application Ser. No. 63/567,650, filed on Mar. 20, 2024. The entire contents of the foregoing are incorporated herein by reference.

### FEDERALLY SPONSORED RESEARCH OR DEVELOPMENT

This invention was made with government support under CMMI2038403 awarded by the National Science Foundation. The government has certain rights in the invention.

### FIELD OF THE DISCLOSURE

The disclosure relates to vehicle intrusion detection and more specifically, to vehicle intrusion detection using monocular cameras.

### BACKGROUND

Camera-based tracking systems often use stereo cameras (e.g., dual cameras) to measure distances. For example, multiple cameras on a vehicle are used to determine distances, such as distances to an object, e.g., other vehicles or markers on the road. Sometimes additional sensors, e.g., radar, are used together with cameras for distance determination or tracking the location of the object. Some camera-based systems determine a distance approximation based on assumptions relating to the height and width of the target that are based on pre-determined target sizes, e.g., the average size of a passenger vehicle or a commercial vehicle.

### SUMMARY

Disclosed herein are methods and systems for using a monocular camera to provide an estimated time from encounter between an object and a spatial region of interest. The methods and systems accurately determine and track the estimated time from encounter using monocular camera systems (e.g., one camera).

In general, an aspect disclosed herein is a method of determining an estimated time to encounter using a monocular camera. The method includes receiving an image from a camera. The method includes identifying an object from the image data. The method includes calculating a scaled distance between the object and a region of interest based on the image data. The method includes calculating a scaled velocity based on the scaled distance. The method includes calculating an estimated time from encounter until the object will encounter the region of interest based on the scaled distance and the scaled velocity.

Examples may include one or more of the following features. The camera can be mounted to a vehicle, a user, a work zone, a road hazard, or a road information indicator and the region of interest contains the camera, the vehicle, the user, the work zone, the road hazard, or the road information indicator. Calculating the estimated time from encounter can be based on a ratio of the scaled distance to the scaled velocity. The object can be identified using a computer vision algorithm. The method may include comparing the estimated time from encounter to an encounter threshold and, if the estimated time from encounter is less than the encounter threshold, indicating a predicted encounter. Determining the scaled distance may include using an image height and scaled location of the image of the object and the focal length or other parameters of the camera. Determining the scaled distance may include determining a ratio between the image height of the image of the object and the scaled focal length. Determining the scaled distance may include determining a first scaled distance in a first dimension or direction and a second scaled distance in a second dimension or direction. The first scaled distance can be determined using a different method than the second scaled distance. Calculating the scaled velocity may include determining a derivative of the scaled distance. Determining the derivative of the scaled distance may include using a state observer algorithm, a neural network, a vehicle model, or numerical differentiation. Determining the scaled distance may include applying a correction factor and an offset correction factor to the scaled distance to determine a corrected scaled distance. Calculating the estimated time from encounter may include calculating a first estimated time from encounter in the first dimension and a second estimated time from encounter in the second dimension. Calculating the first estimated time from encounter may include calculating a ratio between the first scaled distance and a first scaled velocity and calculating the second estimated time from encounter may include calculating a ratio between the second scaled distance and a second scaled velocity. The method may include comparing the first estimated time from encounter to a first encounter threshold or the second estimated time from encounter to a second encounter threshold, and, if the first estimated time from encounter is less than the first encounter threshold or the second estimated time from encounter is less than the second encounter threshold, or if both the first time from the encounter and second time from the encounter are less than the first and second encounter thresholds respectively, indicating an predicted encounter. The method may include comparing a linear or nonlinear combination of the first and second estimated time from encounter to a third encounter threshold and if the combination of the first and second estimated time from encounter is less than the third encounter threshold, indicating a predicted encounter. Indicating the predicted encounter may include displaying, on a display and for viewing by a user, a predicted encounter notification. Indicating the predicted encounter may include producing an audible notification. Determining the scaled distance may include using a focal length of the camera, an image height of the image of the object, a lateral image position of the object, and a pixel coordinate of a principal point of the camera.

In general, an aspect disclosed herein is a system for determining an estimated time to encounter using a monocular camera. The system includes a camera. The system includes a controller, including a processor and a non-transitory storage medium storing instructions that when executed by the processor cause the controller to: receive an image from a camera, identify an object from the image, calculate a scaled distance between the object and a region of interest based on the image, and calculate a scaled velocity based on the scaled distance, calculate an estimated time from encounter until the object will encounter the region of interest based on the scaled distance and the scaled velocity.

Examples may include one or more of the following features. The object can be identified using a computer vision algorithm. The camera can be mounted on a vehicle. The camera can be mounted on a stationary object. The camera can be mounted to a vehicle, a road hazard, a road safety indicator, or a road information indicator and the region of interest contains the camera, the vehicle, the user, the work zone, the road hazard, or the road information indicator. The camera can be a monocular camera. The system may include a notification system, and the controller configured to compare the estimated time from encounter to an encounter threshold and, if the estimated time from encounter is less than an encounter threshold, command the notification system to produce a notification indicative of the estimated time from encounter being lower than the encounter threshold.

Particular implementations of the subject matter described in this specification can be implemented so as to realize one or more of the following technical advantages.

The methods and systems described herein accurately determine and track the estimated time from encounter using monocular camera systems thereby reducing the cost and complexity of monitoring estimated time from encounters between the system and tracked objects.

The estimated times from encounter are determined from image data received from the monocular camera using an assumption that the height of the object in the camera coordinate system is constant. This allows for rapid determination of the estimated times from encounter by avoiding estimation of any dimension of the object in the camera coordinate system thereby reducing computation time.

The methods and systems described herein determine the estimated time from encounter by estimating the ratio of the scaled distance to the scaled velocity of an object thereby increasing the flexibility of tracking a variety of objects without requiring pre-determined dimensions of the objects.

The methods and systems described herein use monocular camera systems which reduces the cost and physical size of the systems and increase the locations at which the systems can be mounted.

The methods and systems described herein are scalable to an arbitrary camera model and therefore can be used with any single camera, thereby increasing the deployment flexibility.

The methods and systems described herein are useable in road-based situations to protect a broad range of zone sizes, including work zones or personal zones. This allows warning systems for personal use on or near a vehicle or for protecting large zones which can include multiple people.

The details of one or more embodiments are set forth in the accompanying drawings and the description below. Other features and advantages will be apparent from the description and drawings, and from the claims.

### DESCRIPTION OF DRAWINGS

FIG. 1 is a schematic illustration of a monocular camera system determining estimated time from encounters in a first road environment.

FIG. 2A is a top-down schematic illustration of a monocular camera system determining estimated time from encounters in a second road environment.

FIG. 2B is a schematic illustration of an image collected by the monocular camera system and the scaled object dimensions determined based on the image.

FIG. 3 is a schematic illustration of a monocular camera system determining estimated time from encounters in a third road environment.

FIG. 4 is a flow chart diagram of a method of using computer vision to provide an estimated time from encounter between an object and a spatial region of interest.

FIG. 5 is a schematic diagram illustrating an example algorithm for determining an estimated time to encounter.

FIG. 6 is a schematic illustration of a computer system which can provide the systems described herein.

In the figures, like references indicate like elements.

### DETAILED DESCRIPTION

Disclosed herein are methods and systems for determining an estimated time from encounter (e.g., the estimated amount of time it would take for two objects/spaces to meet) between one or more objects and a camera or a region of interest. The camera can be mounted to a vehicle or on a boundary of a spatial region of interest. The spatial region of interest can be considered a “protected region.” In general, it is desirable to prevent the protected region of interest from intrusion from the objects. In some examples, the protected region of interest includes a user, multiple users, or a protected object. The systems are deployable in road environments for estimating and monitoring estimated time from encounters between vehicles and the protected zones. Some examples of protected zones include a construction zone on a road. Another example includes a camera mounted near a vulnerable user, e.g., a camera mounted to a bicycle, a bicyclist, a scooter, or a scooter user. Another example includes a traffic intersection in which the status of the traffic signal (e.g., a red signal) advises a vehicle to stop and not traverse traffic intersection. Another example includes pedestrian region of interest in which pedestrians either are or may be present.

In some examples, the position of the camera is on at least one boundary of the region of interest, such as an edge or corner of the region of interest. In some examples, the camera is mounted on or near a boundary of a region of interest in which people are performing maintenance. The camera then estimates estimated time from encounters based on the motion of objects that may encounter the camera, or edge of the protected region of interest. In another example, the camera is attached to a road vehicle to estimate the estimated time from encounter of the road vehicle to another object. The objects can include one or more road objects, e.g., pedestrians, cyclists, safety markers, or other vehicles.

In general, reference axes are shown herein for an example coordinate system having dimensions X, Y, and Z. As used herein, references to “lateral,” “vertical,” and “longitudinal” directions will refer to the X, Y, and Z directions, respectively. Therefore, a lateral distance refers to a distance in the X-direction, and a longitudinal distance refers to a distance in the Z-direction with respect to the reference axis.

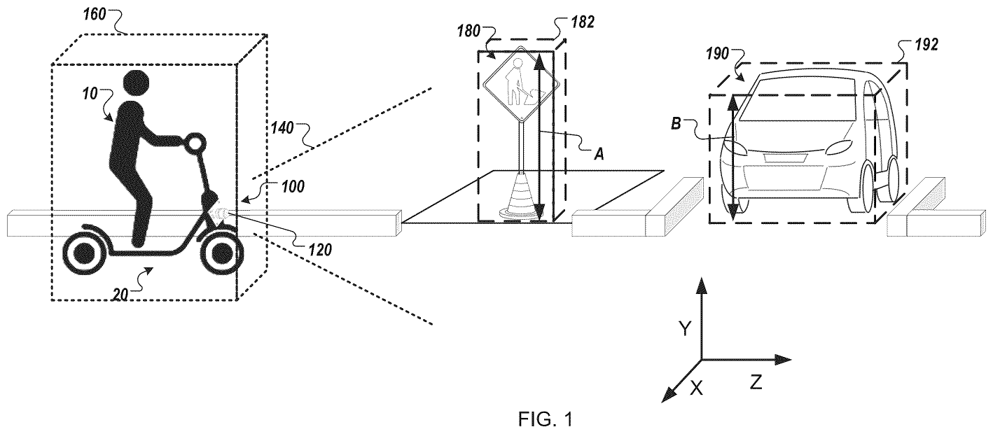

A user 10 operating a vehicle 20 on a road is shown in FIG. 1. In general, the vehicle 20 operates on a road on which other road objects appear. Encounters, e.g., collisions, or encroachments, between the vehicle 20 and other objects on the road can be dangerous for the user 10 of the vehicle 20. A system 100 for determining whether a monitored spatial region of interest 160 will have an encounter with objects on the road is installed to the vehicle 20. The system 100 monitors image data received from a camera 120 mounted to the vehicle 20 for objects that may an encounter the camera 120, or the spatial region of interest 160 which the camera 120 is monitoring. The system 100 reduces the risk of injury or harm to the user 10 by monitoring the objects and estimating an estimated time from encounter between each of the objects and the camera 120.

The camera 120 generates image data based on a field of view 140 of the camera 120. The system 100 monitors the image data for objects that appear in the field of view 140. The system 100 can identify multiple objects in the field of view 140 using a single camera 120. In the example of FIG. 1, there are two objects in the field of view 140: a road sign 180 and a car 190. The system 100 processes the image data and applies an object identification algorithm, e.g., a computer vision algorithm, to identify the objects in the image data, such as the sign 180 and the car 190.

Once the objects have been identified in the image data, the system 100 determines an estimated time from encounter between each of the objects and the spatial region of interest 160. To determine the estimated time from encounter, the system 100 determines a scaled distance between a particular object and the spatial region of interest 160 and a rate at which that scaled distance is changing.

The system 100 includes a single camera 120 so the system 100 determines the scaled distances based on information from an image plane of the camera 120 and one or more camera parameters, e.g., the focal length of the camera 120. This information allows the system 100 to predict whether the identified objects will encounter the spatial region of interest 160 or safely pass by the spatial region of interest 160, using only a single camera 120.

The system 100 determines a scaled distance between each identified object and the region of interest 160. The scaled distance is a distance estimate based on the size and position of the object in the image data and the focal length of the camera 120. In some examples of how the system 100 determines the scaled distance, the system 100 uses a computer vision algorithm to create bounding box 182 around the sign 180 and bounding box 192 around the car 190.

The system 100 then determines an estimated height of the image of the object in the image data by determining a height of the bounding box (e.g., bounding box 182 or bounding box 192) from the image data. As shown in FIG. 1, the system 100 determines an image height A for the sign 180 and an image height B for the car 190. The system 100 uses the image height A to determine the scaled distances for the sign 180 and image height B to determine scaled distances for the car 190.

In general, the scaled distance changes based on motion of the system 100 and motion of the object. For example, the scaled distance between the vehicle 20 and sign 180 changes based on motion of the vehicle 20, and the scaled distance between the vehicle 20 and the car 190 changes based on the motion of the vehicle 20 and motion of the car 190. If the vehicle 20 is moving at one speed toward the sign 180, the scaled distance decreases based on the speed; if the vehicle 20 and the car 190 are each moving toward each other, the scaled distance between them will decrease at a higher rate than if one were motionless. Similarly, if the vehicle 20 is moving away from the sign 180 or car 190, the respective scaled distance increases.

The system 100 is configured to determine scaled distances in one or more dimensions. In some examples, the system 100 determines a lateral scaled distance and a longitudinal scaled distance, e.g., a scaled distance in each of the X and Z directions, between the region of interest 160 and the sign 180 and car 190, respectively. In some examples, the system 100 is configured to determine vertical scaled distances in addition to the lateral and longitudinal scaled distances.

Using monocular scaled distances reduces calculation complexity compared to determining real world coordinate estimates of distances and velocities by only performing calculations based on image height and location of the image of the object and the focal length of the camera. Further, this reduces calculation time required to track changes in the scaled distances and velocities to determine the estimated time from encounter.

To determine the estimated time from encounter between the objects and the spatial region of interest 160, the system 100 determines the scaled distances and the rate at which the scaled distances are changing, termed the “scaled velocity.” The system 100 determines the scaled velocity in each dimension the scaled distance is determined, e.g., the system determines a lateral scaled velocity using a lateral scaled distance, a longitudinal scaled velocity using a lateral scaled distance, or both.

The value of the scaled velocity indicates whether the scaled distance is changing over time, e.g., whether the object is or is not approaching the region of interest 160. If the scaled velocity is negative, the scaled distance is decreasing and the object is approaching the region of interest 160 or camera 120. If the scaled velocity is zero, the scaled distance is constant and the object is not approaching the region of interest 160. If the scaled velocity is positive, the scaled distance is increasing and the object is moving further from the region of interest 160. In examples in which multiple scaled distances are tracked, e.g., a lateral and a longitudinal scaled distance, the system 100 determines the scaled velocity for each of the scaled distances, e.g., a lateral and a longitudinal scaled velocity. The terms “negative” and “positive” in this example are exemplary, the values may be reversed, or other scalar parameters may be used.

The system 100 uses the scaled distance and the scaled velocity to calculate an estimated time from encounter for each identified object. In some examples, the system 100 uses a ratio between the scaled distance and the scaled velocity (e.g., the scaled distance divided by the scaled velocity) to determine the estimated time. The height of the object in the camera coordinate system is assumed to be constant. This allows the ratio between the scaled distance and the scaled velocity to result in an estimated time value that is independent of the real-world height of the object.

The system 100 determines, for each object, an estimated time to encounter for at least one, e.g., each, dimension the scaled distances and velocities are being determined. The system 100 uses the ratio between the scaled distances and the scaled velocities to determine the estimated time to encounter. In the example herein, the system 100 determines a lateral estimated time to encounter and a longitudinal estimated time to encounter using the lateral and a longitudinal scaled distances and velocities, respectively.

The system 100 stores in memory a threshold value indicative of an estimated time to the predicted encounter between the tracked objects and the spatial region of interest 160. A predicted encounter between the object and the spatial region of interest 160 is not expected if the estimated time is large. A predicted encounter between the object and the spatial region of interest 160 is imminent if the estimated time to encounter is small.

The system 100 compares the estimated time in each dimension to the respective threshold value. The estimated time in one or more dimensions being less than the respected threshold value can indicate an imminent encounter between the detected object and the spatial region of interest 160 or the camera 120. In some examples, the system 100 determines a linear or nonlinear combination of the estimated time to encounter in one or more dimensions. In some examples, the system 100 compares the combined time to encounter values to a combined threshold value. Such examples are useful when the region of interest is rotated with respect to the camera coordinate system, when determining a distance for the region of interest 160 containing the vehicle 20 to come to a stop to prevent the detected object from intruding into the region of interest 160, or both.

In some examples, the system 100 includes a notification system for providing notifications to a user. If the estimated time from encounter is within, e.g., less than, one or more of the threshold values, the system 100 generates a notification that a predicted encounter between the object and the spatial region of interest 160 is possible within the estimated threshold time. In this manner, the system 100 can provide increased safety for users or objects within the region of interest 160. The notification system may include a screen, a speaker, or a visual notifier (e.g., a light). Some examples of the notification the system 100 may generate for the user 10 include a displayed notification, e.g., a visual notification, or a noise for alerting the user 10, e.g., an audible notification.

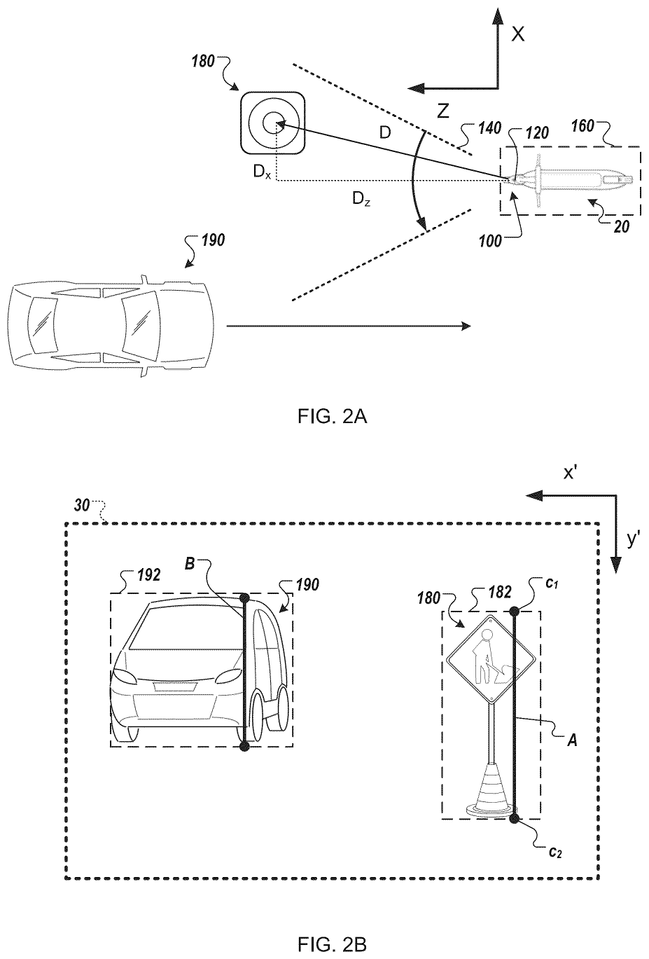

Additional details related to how the system 100 determines the scaled distances are shown with respect to FIGS. 2A and 2B. A top-down view of the environment of the vehicle 20, the spatial region of interest 160, the car 190, and the sign 180 is shown in FIG. 2A. The user 10 is removed for visual simplicity.

The system 100 has a camera 120 facing forward to monitor the traffic in front the vehicle 20 (e.g., ahead of, the direction in which the vehicle 20 is traveling). In general, the camera 120 is installed or mounted on or a near a boundary of the region of interest 160 which the system 100 is configured to monitor. The region of interest 160 can include an object for which encounters with other objects and/or road hazards should be avoided.

In general, the system 100 can have more than one camera 120 for monitoring multiple fields of view. In other examples, the camera 120 is mounted on the rear to monitor the traffic behind the vehicle 20, or on the sides of the vehicle 20. Such examples can be provided as multiple systems each having one camera, or one system can operate multiple cameras. In examples in which multiple cameras are operating, the cameras are arranged to have different fields of view to monitor the region of interest 160 for encounters from different angles.

The camera 120 generates image data that the system 100 uses to determine whether a predicted encounter between the camera 120 and the objects is expected to occur. The camera 120 receives image data containing an image of the objects in the field view 140. The field view 140 spans a range of angles, shown by the arc arrow in FIG. 2A, which depends on the camera 120 optical parameters. In this instance, the camera 120 generates image data which contains representations of the car 190 and the sign 180.

In general, the image data includes representations of the objects in the field of view 140 as seen at the focal plane of the camera 120. An example image 30 containing representations of the car 190 and sign 180 is shown in FIG. 2B. The system 100 processes the image data using the computer vision algorithm to detect and localize objects in the image data. Examples of the computer vision algorithm include object detectors, key-point detectors, neural networks (e.g., YOLO), or image segmentation algorithms. In some examples, the system 100 processes the image data to classify the detected objects using a classification algorithm.

The system 100 may use the computer vision algorithm to determine a bounding box for each object in the image data of the image 30. One example includes of determining the bounding boxes includes constructing an estimated three-dimensional rectangular prism that circumscribes the objects from the image data. The rectangular prism is used to determine a two-dimensional projection of the prism that results in the bounding box in the image 30.

Object detection algorithms for determining the bounding boxes include using local filters,, or neural networks. Examples of the neural network can include object detectors (e.g., YOLO), keypoint detectors, polygonal bounding box detectors, image segment detectors, 3D bounding box detectors, or any combination of these.

The system 100 determines an image height of each object in the image 30 based on the vertical dimension of the bounding box. The image heights may be determined by calculating a length of a line segment from one edge of the projected bounding boxes to the opposing edge, e.g., the top and bottom edges of the box 182 and box 192. As used herein, the term image height is used to describe the height of the object detected in the image data.

In some examples, the image height may be determined by calculating a length of a line segment from one edge of a detected segment to the opposing edge using image segmentation algorithms,, from one edge of a projected 3D bounding box to the opposing edge using 3D bounding box detectors, from one key-point to one opposing key-point obtained from a key-point detector, from one edge to the opposing edge of a polygonal bounding box, or any combination of these.

The length of the line segments defines the image height which is used to determine the scaled dimension, scaled location, or both for each object. The line segments can be determined at any point in the bounding box and in some examples, the line segments are determined at an edge of the associated bounding box. One example of determining a vertical image height is determining a difference between two coordinates in the image on the same vertical line, e.g., y₂−y₁.

The system 100 determines scaled distances for each of the identified objects using the image height of the object. The scaled distance is a ratio between the distance to an object, D, and the real height of the object on the road. The real height of the object is assumed to be constant with time. The scaled distance can be determined in multiple dimensions, such as the lateral scaled distance, Dₓ, the longitudinal scaled distance, D_{z}, or both. The scaled distance can be determined using a single image from the sequence and updated based on a new image in the sequence.

In some embodiments, the system 100 determines a scaled location for each of the identified objects. The scaled location is the ratio of the location of the object with respect to the camera to the object's size. The object's size can be defined as one dimension of the object determined in the image data. As used herein, the primary dimension refers to the image height of the object, but in other examples, it could be the image width, image length, an arbitrary image dimension to find within the detected object, or any combination of these.

The scaled distances, scaled locations, or both, are determined using a camera model representing the camera 120 and one or more camera properties. The camera 120 is a single-lens camera, and an example camera model to describe such a camera is a pin-hole model. Further details for using a pinhole camera model are described herein with respect to Example 1. The camera model describes the relationship between coordinates in the camera coordinate system (e.g., the environment shown in FIG. 2A, e.g., X, Y, Z) and the projected coordinates in the image coordinate system (e.g., x′, y′ in FIG. 2B. The coordinate direction z′ is into the page in FIG. 2B).

Image data represents projections of light rays incident on the camera 120. Each pixel corresponds to a specific ray and the direction of the ray associated with each pixel can be determined using camera models. The systems and methods described herein can be used for monocular cameras, e.g., using a single-viewpoint camera model. Specific cases of this model include a radially symmetric model or a pin-hole camera model.

The camera model may describe the number of apertures and the type of lenses used for each aperture. In the example of a pin-hole camera, the camera 120 includes a single aperture which may include a single lens. The type of lens used with camera 120 alters the field of view of the camera 120, e.g., the way incident lights rays are projected to the sensor of the camera 120. Examples of lenses to be used with the camera 120 include wide angle lenses (e.g., fish-eye lenses), ultra-wide angle lenses, telephoto lenses, macro lenses, or periscope lenses.

The camera model used with camera 120 may include one or more modifications that describe the type of lens used with the camera 120. In some examples, the lens may be designed to provide a specific projection of incident light rays onto the camera sensor. This can include a stereographic projection, in equidistance projection, an equisolid angle projection, or an orthogonal projection.

The system 100 determines a pixel coordinate for each end of the line segment as the image height. For example, image height A for the sign 180 can be determined using the difference between image coordinates c₁ and c₂, e.g., |c₁-c₂|.

The system determines the scaled distances in each tracked dimension using the image height and the scaled focal lengths of the camera 120 in the tracked dimensions. In some examples, the system 100 uses the ratio between the scaled focal length of the camera and the image height to determine the longitudinal scaled distance. In another example, the system 100 uses the scaled focal lengths in the lateral and longitudinal dimensions, the image height, a lateral image position, and a pixel coordinate of the principal point of the camera 120, e.g., a pixel coordinate where the optical axis of the camera 120 passes through the image.

The system 100 determines scaled velocities for each of the scaled distances. The scaled velocities are derivatives of the scaled distances and describe how the scaled distances change over time. An example of determining a scaled velocity includes using a numerical differentiation method from consecutive time-sampled images. One or more smoothing filters may be used to smooth the results. Another example includes using vehicle models in which velocities are related to positions and other variables. Another example includes using model-based algorithms such as linear or non-linear observer models or estimation algorithms for calculating the scaled velocities using the scaled distances. Another example includes using a neural network trained to determine the scaled velocities based on the scaled distances. In some examples, the system 100 determines scaled accelerations in addition to the scaled velocities and scaled distances (e.g., as the derivative of the scaled velocity).

The system 100 determines estimated time from encounters based on the scaled distances and the scaled velocities. One example of how the system 100 determines the estimated time is by determining the ratio of the scaled distance to the scaled velocity for each tracked dimension. For example, the system 100 determines the estimated time by dividing the scaled distance by the scaled velocity.

In some examples, the system 100 is configured to determine the changes in the estimated time over time, e.g., the derivative of the estimated time from encounter. The system 100 can determine the derivative of the estimated time from encounter through any means described herein. The derivative of the estimated times can be determined using the scaled accelerations, scaled velocities, and scaled distances. The scaled accelerations are the derivative of the scaled velocities, or the double derivative of the scaled distances.

The sign 180 and car 190 are two examples of objects that the system 100 can identify. Other examples include different vehicles (e.g., buses, bikes, motorcycles, trucks, commercial fleet vehicles, vans, semi-trucks, or trailers), beings (e.g., pedestrians, or animals), zones (e.g., construction zones, residential zones, commercial zones), road information indicators (e.g., traffic signals, signage, or crosswalks), plants (e.g., trees, or bushes), or other objects identifiable by the computer vision algorithm implemented by the system 100. The system 100 is shown installed to the vehicle 20 operated by the user 10. In general, the system 100 can be used by vehicles which are not operated by a user, e.g., an autonomous vehicle.

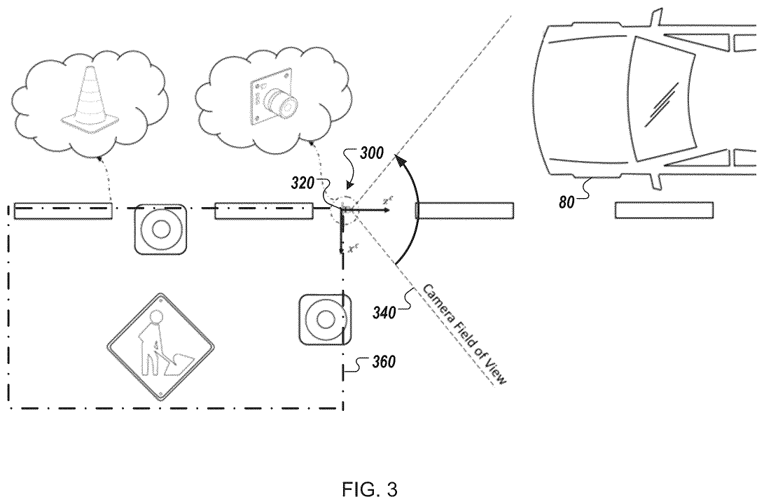

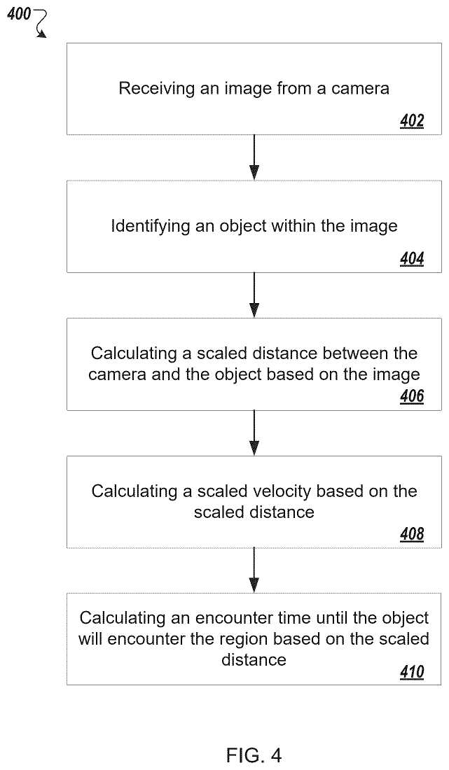

A second road environment including a system 300 monitoring a spatial region of interest 360 for predicted encounters enclosing a construction zone is shown in FIG. 3. The system 300 includes a monocular camera 320 adjacent a corner of the region of interest 360 which can be mounted to a stationary object, e.g., a cone, a pole. The camera 320 receives image data from the field of view 340 facing the direction of traffic to monitor the region of interest 360 for predicted encounters with oncoming traffic. In this manner, the system 300 increases the overall safety of users operating within the region of interest 360 by producing indications of the predicted encounter between the region of interest 360 and the vehicle 80.

A vehicle 80 is shown in the field of view 340. The system 300 is shown having coordinate axes x^{c} and z^{c} indicating that the system 300 monitors the scaled distance and scaled velocities of vehicle 80 in the lateral and longitudinal dimensions.

The system 300 stores thresholds for the lateral and longitudinal estimated times and compares the calculated estimated times with the thresholds to determine if a predicted encounter is expected to occur. A number of predicted encounter thresholds are discussed herein for the region of interest 360. The encounter thresholds discussed with respect to system 300 are applicable to the system 100 monitoring the spatial region of interest 160 of FIG. 1 as well.

If the longitudinal estimated time from encounter is small, the lateral scaled distance is positive, and the lateral estimated time from encounter is greater than the longitudinal estimated time from encounter for the region of interest 360, an estimated encounter is indicated. If the longitudinal estimated time from encounter is zero and the lateral scaled distance is positive for the region of interest 360, the predicted encounter has happened.

If the longitudinal estimated time from encounter is small, lateral scaled distance is positive, but lateral estimated time from encounter is less than the longitudinal estimated time from encounter for the region of interest 360, the vehicle 80 is getting close to the zone 360.

If the longitudinal estimated time from encounter is small, lateral scaled distance is negative, and lateral estimated time is greater than the longitudinal estimated time from encounter, the vehicle 80 is passing by safely.

If the longitudinal estimated time from encounter is small, lateral scaled distance is negative, but lateral estimated time is less than the longitudinal estimated time from encounter for the region of interest 360, it means that the vehicle is initially in the safe lane but an encounter is expected to happen.

If the longitudinal estimated time from encounter is small for the region of interest 360, an encounter is expected to happen. If the longitudinal estimated time from encounter is zero for the region of interest 360, the encounter has happened. A large longitudinal estimated time from encounter for the region of interest 360 indicates that the vehicle is either static or safely approaching the zone.

Disclosed herein is a method 400 for using computer vision to provide an estimated time from encounter between an object and a spatial region of interest. The method 400 can be implemented on the system 100 described herein.

Spatial data that defines a spatial region of interest is received (step 402). The spatial data defining the spatial region of interest is stored by system. The spatial data can be pre-determined and stored in memory of the system. In other examples, the spatial data can be input into the system, or updated, by a user.

Image data is received from a camera (step 402). The camera receives image data, e.g., an image, from a focal plane in a field of view. In some examples, multiple streams of image can be received from multiple cameras.

At least one object is identified from the image data (step 404). One or more objects are identified from the image data by a processor performing the method. Identifying the objects can include using computer vision algorithm, such as an object detection algorithm, to identify the object. In some examples, identifying the object includes defining a bounding box which surrounds the object in the image data.

A scaled distance between the object and the spatial region of interest is calculated (step 406). The scaled distance is a ratio of the height of the object in the image data to the scaled focal length of the camera. The scaled distance can be calculated in multiple dimensions, e.g., the two dimensions of the image data. In some examples, a longitudinal scaled distance and a lateral scaled distance are calculated.

A scaled velocity based on the scaled distance is calculated (step 408). The scaled velocity reflects how the scaled distance is changing over time. The scaled velocity is a measure of how the distance between the object and the region of interest is changing, e.g., increasing, decreasing, or staying the same. The scaled velocity is determined by calculating a derivative of the scaled distance for each dimension. In the previous example, a longitudinal scaled velocity and a lateral scaled velocity is determined. Examples of methods to determine the scaled velocity include a state observer algorithm, a neural network, a vehicle model, or numerical differentiation.

An estimated time from encounter until the object will encounter the region of interest is calculated based on the scaled distance and the scaled velocity (410). The estimated time from encounter is calculated for each dimension in which the scaled distance and scaled velocity was calculated. Based on the previous example, longitudinal and lateral estimated time from encounters are calculated based on the longitudinal and lateral scaled distances and velocities, respectively.

Optionally, the estimated times are compared to an encounter threshold. The encounter threshold is a value stored by the system performing the method indicative of a minimum safe value before which the object will encounter the region of interest. If the estimated time is less than an encounter threshold, a predicted encounter is flagged.

Optionally, the method can include indicating the predicted encounter, such as indicating to a user that the predicted encounter may occur. The indicating can include displaying, on a display and for viewing by the user, a predicted encounter notification such as text indicative of the encounter, or a suggested course of action to take to reduce the chances of the encounter. Other examples of the indication include an audible indication, e.g., an alert noise.

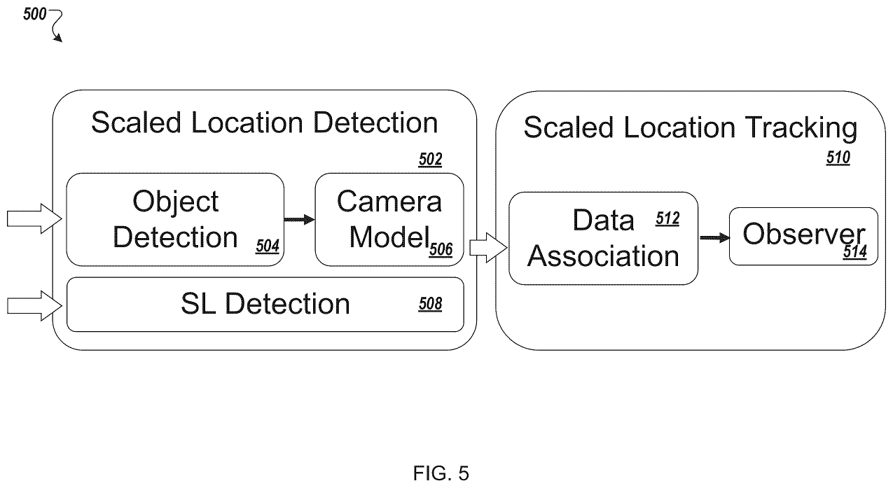

FIG. 5 is a schematic diagram illustrating an example algorithm 500 for executing the methods of determining an estimated time to encounter as disclosed herein. The algorithm 500 can be stored in non-transitory medium and executed by one or more processors of the systems disclosed herein. The schematic shows that the scaled location may be obtained using object detection algorithms and a camera model or neural network that obtains scaled locations of objects directly.

The algorithm 500 includes a scaled location detection engine 502 and a scaled location tracking engine 510. The scaled location detection engine 502 uses image data received from a camera to determine a scaled location of objects in the field of view of the camera. The scaled location detection engine 502 includes an object detection module 504. The object detection module 504 processes image data received from the camera to determine the presence of an object in the camera field of view provided by the image data. The object detection module 504 uses an object detection process, such as a computer vision algorithm, to determine the presence of one or more objects in the image data.

The object detection module 504 processes the image data to determine the presence of the one or more objects. The object detection module 504 provides data representing the presence of the one or more objects to a camera model module 506. The camera model module includes one or more camera models which describes a camera, such as the camera that generated the image data. An example of the camera model can include any described herein, including a pin-hole model, which describes a pin-hole camera. The camera model module 506 processes the received data to determine a scaled location of the objects detected in the image data.

In some examples, the scaled location detection engine 502 includes a scaled location detection module 508. The scaled location detection module 508 includes one or more scaled location detection processes, which can perform object detection and scaled location determination. Examples of scaled location detection processes that can perform object detection and scaled location determination include machine learning models trained to determine scaled location from image data, such as a neural network.

The scaled location detection engine 502 can include the object detection module 504, the camera model 506, the scaled location detection module 508, or any combination of these. In some examples in which the scaled location detection engine 502 includes the machine learning model trained to determine scaled location from image data, the scaled location detection engine 502 may only include the scaled location detection module 508.

The algorithm 500 includes a scaled location tracking engine 510. The scaled location detection engine 502 provides the determined scaled location and object data to the scaled location tracking engine 510. The scaled location tracking engine 510 processes the received data to determine how the scaled location of the objects changes over time. The scaled location tracking engine 510 monitors the objects and their scaled locations to calculate the estimated time to encounter for objects determined by the scaled location detection engine 502.

The scaled location tracking engine 510 includes a data association module 512 and an observer module 514. The data association module 512 associates newly detected objects with previously detected objects at each time step. In the example of FIG. 1, the data association module 512 determines that the road sign 180 and the car 190 are detected in the image data collected at a first time stamp. The camera 120 subsequently generates new image data which is provided to the scaled location tracking engine 512. The data association module 512 determines that a detected sign in the subsequent image data is the road sign 180 detected in the previous image data. The data association module 512 determines that a detected car in the subsequent image data is the car 190 detected in the previous image data.

The observer module 514 processes received information to determine a scaled velocity of the objects detected in the image data. The scaled velocity allows the scaled location tracking engine 510 to monitor objects in received image data and determine estimated time to encounters for each object detected in the image data. The observer module 514 determines a scaled velocity for each object detected in the image data. The observer module 514 can include any example of methods or algorithms to determine the scaled velocity as described herein, such as a state observer algorithm, a neural network, a vehicle model, or numerical differentiation.

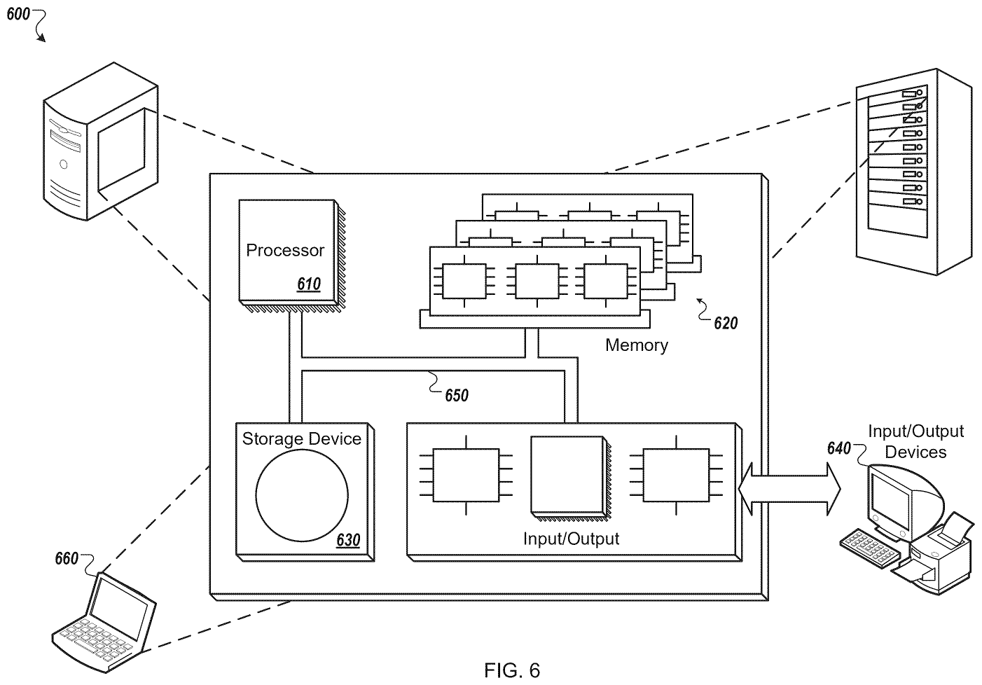

FIG. 6 is a block diagram of an example computer system 600. For example, referring to FIG. 1, the system 100 could be an example of the system 600 described here. The system 600, e.g., the controller 600, includes a processor 610, a memory 620, a storage device 630, and one or more input/output interface devices 640. Each of the components 610, 620, 630, and 640 can be interconnected, for example, using a system bus 650.

The processor 610 is capable of processing instructions for execution within the system 600. The term “execution” as used here refers to a technique in which program code causes a processor to carry out one or more processor instructions. In some implementations, the processor 610 is a single-threaded processor. In some implementations, the processor 610 is a multi-threaded processor. The processor 610 is capable of processing instructions stored in the memory 620 or on the storage device 630. The processor 610 may execute operations such as using computer vision algorithms to process image data and determine whether a spatial region of interest will have an encounter.

The memory 620 stores information within the system 600. In some implementations, the memory 620 is a computer-readable medium. In some implementations, the memory 620 is a volatile memory unit. In some implementations, the memory 620 is a non-volatile memory unit.

The storage device 630 can provide mass storage for the system 600. In some implementations, the storage device 630 is a non-transitory computer-readable medium. The input/output interface devices 640 provide input/output operations for the system 600. In some implementations, the input/output interface devices 640 can include one or more network interface devices, e.g., a wireless interface device, e.g., an 802.11 interface, a 3G wireless modem, a 4G wireless modem, etc.

A network interface device allows the system 600 to communicate, for example, transmit and receive data such as the spatial data defining the spatial region of interest 160 or the image data generated by the camera 120. In some implementations, the input/output device can include driver devices configured to receive input data and send output data to other input/output devices, e.g., keyboard, printer, and display devices 660. In some implementations, mobile computing devices, mobile communication devices, and other devices can be used.

In some examples, the system 600 is contained within a single integrated circuit package, e.g., an ASIC or FPGA. A system 600 of this kind, in which both a processor 610 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 640.

The components of the system can be interconnected by any form or medium of digital data communication, e.g., a communication network. Examples of communication networks include a local area network (“LAN”) and a wide area network (“WAN”), e.g., the Internet.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

### Examples

### Example 1-Pinhole Camera Model Scaled Distance Estimation

A pinhole camera model formulation for determining estimated time from encounter is described with respect to Example 1. The pinhole camera model describes the relation between the 3D coordinates of a point in the camera coordinate system, e.g., real space, and projected coordinates in the 2D image coordinate system, e.g., the two-dimensional image plane at a focal length from the camera. A point in the 3D camera coordinate system was considered and located at (x^{c}, y^{c}, z^{c}). The 2D projected pixel coordinates of this point on the image plane were denoted as (xⁱ, yⁱ). The scaled focal lengths of the camera in the lateral and vertical (e.g., X and Y) dimensions were denoted as fₓ and f_{y}. Variables cₓ and c_{y} were the pixel coordinates in the image coordinate system of the principal point, e.g., where the optical axis of a camera passes the image plane.

$${x}^{i} \approx {f}_{x} \times \frac{{x}^{c}}{{z}^{c}} + {c}_{x}$$

$${y}^{i} \approx {f}_{y} \times \frac{{y}^{c}}{{z}^{c}} + {c}_{y}$$

The height of a vertical line A̅B̅ was termed h in the camera coordinate system. The coordinates of the two end points of the line A̅B̅ (e.g., A and B are (x_{A}^{c}, y_{A}^{c}, z_{A}^{c}) and (x_{B}^{c}, y_{B}^{c}, z_{B}^{c}) in the camera coordinate system. The corresponding coordinates of the two end points (e.g., A′ and B′) in the image coordinate system are (x_{A}ⁱ, y_{A}ⁱ) and (x_{B}ⁱ, y_{B}ⁱ) respectively.

The scaled distances (e.g., ratio of longitudinal and lateral distances to height or

$$\frac{{z}_{AB}^{c}}{h} and \frac{{z}_{AB}^{c}}{h} )$$

for the line A̅B̅ (Z_{B}^{c}≈Z_{A}^{c}≈Z_{AB}^{c} and x_{A}^{c}≈x_{AB}^{c}) with height of h (y_{B}^{c}-y_{A}^{c}=h) was determined using the formulation presented below.

$$\begin{matrix}{y}_{{A}^{′}}^{i} \approx {f}_{y} \times {y}_{A}^{c} / {z}_{A}^{c} + {c}_{y} \\ {y}_{{B}^{′}}^{i} \approx {f}_{y} \times {y}_{B}^{c} / {z}_{B}^{c} + {c}_{y}\end{matrix} \} {⟹}^{{z}_{B}^{c} \approx {z}_{A}^{c}} {y}_{{B}^{′}}^{i} - {y}_{{A}^{′}}^{i} = {f}_{y} \times \frac{{y}_{B}^{c} - {y}_{A}^{c}}{{z}_{AB}^{c}} {⟹}^{{y}_{B}^{c} - {y}_{A}^{c} = h} \frac{{z}_{AB}^{c}}{h} = \frac{{f}_{y}}{{y}_{{B}^{′}}^{i} - {y}_{{A}^{′}}^{i}}$$

$${x}_{{A}^{′}}^{i} \approx {f}_{x} \times \frac{{x}_{A}^{c}}{{z}_{A}^{c}} + {c}_{x} \approx {f}_{x} \times \frac{{x}_{B}^{c}}{{z}_{B}^{c}} + {c}_{x} \times {z}_{B}^{c} \approx {x}_{{B}^{′}}^{i} {⟹}^{{x}_{B}^{c} \approx {x}_{A}^{c} \approx {x}_{AB}^{c}} {x}_{{A}^{′}}^{i} = {x}_{{B}^{′}}^{i} = \frac{{x}_{{A}^{′}}^{i} + {x}_{{B}^{′}}^{i}}{2} = {x}_{{M}^{′}}^{i} = {f}_{x} \times \frac{{x}_{AB}^{c}}{{z}_{AB}^{c}} + {c}_{x} = \frac{{f}_{x}}{{f}_{y}} \times \frac{{x}_{AB}^{c}}{h} ( {y}_{{B}^{′}}^{i} - {y}_{{A}^{′}}^{i} ) + {c}_{x} \frac{{x}_{AB}^{c}}{h} = \frac{{f}_{x}}{{f}_{y}} \frac{{x}_{{M}^{′}}^{i} - {c}_{x}}{{y}_{{B}^{′}}^{i} - {y}_{{A}^{′}}^{i}}$$

Other models may be used to find a similar formulation for the scaled distances. A general formulation to measure the scaled distances is shown below, where functions F_{z} and F_{y} describe the physical model of the camera (e.g., either linear or nonlinear model) and & is the vector including all camera parameters (e.g., focal length, field of view, etc.).

$$\frac{{z}_{AB}^{c}}{h} = {F}_{z} ( \vec{α} , {x}_{{A}^{′}}^{i} , {x}_{{B}^{′}}^{i} , {y}_{{A}^{′}}^{i} , {y}_{{B}^{′}}^{i} ) , \frac{{x}_{AB}^{c}}{h} = {F}_{x} ( \vec{α} , {x}_{{A}^{′}}^{i} , {x}_{{B}^{′}}^{i} , {y}_{{A}^{′}}^{i} , {y}_{{B}^{′}}^{i} )$$

Extrinsic parameters may be used to translate and rotate the formulation presented to represent the scaled distances in an arbitrary coordinate system

$$( e . g . , \frac{{z}_{AB}^{w}}{h} and \frac{{x}_{AB}^{w}}{h} ) .$$

This coordinate system could be on the edge of the zone that is being protected. The measured scaled distances represented in the world coordinate system could be used instead of the ones represented in the camera coordinate system. Therefore, the scaled distances were represented with the variables

$$\frac{{z}_{AB}}{h} and \frac{{x}_{AB}}{h}$$

in the next steps.

Correction factors denoted as γ_{z,1}, γ_{z,2}, γ_{x,1}, and γ_{x,2} could be used to improve the formulations as shown below. In the below formulations, γ_{z,1} and γ_{z,2} are scalar and offset correction factors in the longitudinal direction, and γ_{x,1}, and γ_{x,2} are scalar and offset correction factors in the lateral direction. The correction factors can be used to determine corrected scaled distances used in determining the estimated time from encounters.

$$\frac{{z}_{AB}^{c}}{h} = {γ}_{z , 1} \frac{{f}_{y}}{{y}_{{B}^{′}}^{i} - {y}_{{A}^{′}}^{i}} + {γ}_{z , 2} , \frac{{x}_{AB}^{c}}{h} = {γ}_{x , 1} \frac{{f}_{y}}{{f}_{x}} \frac{{x}_{{M}^{′}}^{i} - {c}_{x}}{{y}_{{B}^{′}}^{i} - {y}_{{A}^{′}}^{i}} + {γ}_{x , 2}$$

Using the pixel coordinates of the image of the two end points (A′ and B′) in 2D image coordinate system, the scaled distances

$$( \frac{{z}_{AB}}{h} and \frac{{x}_{AB}}{h} )$$

were obtained. Once the scaled distances had been obtained, then the derivatives

$$\frac{{\dot{z}}_{AB}}{h} and \frac{{\dot{x}}_{AB}}{h}$$

(i.e., scaled velocities) were also obtained. The scaled velocities were determined using methods described herein. The second derivative of the scaled distances

$$\frac{{\ddot{z}}_{AB}}{h} and \frac{{\ddot{x}}_{AB}}{h}$$

(i.e., scaled accelerations) can also be estimated using methods described herein.

Once the scaled distances and velocities

$$\frac{{x}_{AB}}{h} , \frac{{\dot{x}}_{AB}}{h} , \frac{{z}_{AB}}{h} and \frac{{\dot{z}}_{AB}}{h}$$

were obtained, the estimated time to encounter values with the origin of the coordinate system was computed as follows:

$${TTC}_{x} = \frac{{x}_{AB} / h}{{\dot{x}}_{AB} / h} = \frac{{x}_{AB}}{{\dot{x}}_{AB}} , {TTC}_{z} = \frac{{z}_{AB} / h}{{\dot{z}}_{AB} / h} = \frac{{z}_{AB}}{{\dot{z}}_{AB}}$$

The derivative of longitudinal and lateral time-to-intrusion values,

$$\frac{d}{dt} {TTC}_{x} ,$$

which describe the variations of the estimated time to encounter, were obtained using the measured scaled accelerations, velocities, and distances as follows.

$$\frac{d}{dt} {TTC}_{x} = \frac{{\dot{x}}_{AB} \times {\dot{x}}_{AB} - {x}_{AB} \times {\ddot{x}}_{AB}}{{( {\dot{x}}_{AB} )}^{2}} = \frac{( \frac{{\dot{x}}_{AB}}{h} ) \times ( \frac{{\dot{x}}_{AB}}{h} ) - ( \frac{{x}_{AB}}{h} ) \times ( \frac{{\ddot{x}}_{AB}}{h} )}{{( \frac{{\dot{x}}_{AB}}{h} )}^{2}}$$

$$\frac{d}{dt} {TTC}_{z} = \frac{{\dot{z}}_{AB} \times {\dot{z}}_{AB} - {z}_{AB} \times {\ddot{z}}_{AB}}{{( {\dot{z}}_{AB} )}^{2}} = \frac{( \frac{{\dot{z}}_{AB}}{h} ) \times ( \frac{{\dot{z}}_{AB}}{h} ) - ( \frac{{z}_{AB}}{h} ) \times ( \frac{{\ddot{z}}_{AB}}{h} )}{{( \frac{{\dot{z}}_{AB}}{h} )}^{2}}$$

Once the lateral and longitudinal estimated time from encounters values were obtained, the estimated time from encounters were compared to encounter thresholds to predict an encounter between the region of interest and the object.

### Example 2-Generic Single View Point Scaled Location Dynamics

### Generic Single View Point Models: Forward and Backward Formulations

For a single-view-point camera, rays converge at a single point that is defined to be the center of the camera coordinate system. Therefore, the forward projection mapping for such camera could be formulated as a function of the two angular variables θ and φ. These two angles together represent the direction of the incoming ray. Variable θ is the angle between the ray and the ^{c}Z axis, and φ is the azimuth angle of the ray as seen on the camera coordinate system. The generic single-view-point camera model is described as equation (1):

$${}^{i} P = 𝒜 ◦ 𝒟 ◦ ℱ ( Φ ) \qquad ( 1 )$$

The projection function [symbol] (.) maps the ray angles Φ=[θφ]^{T} into undistorted image coordinates with units of distance. Function [symbol] (.) models the image distortion. Function [symbol] (.) denotes the mapping of the distorted coordinates with units of distance to image coordinates with units of pixels (ⁱP). This function includes information such as the coordinates of the principal point and number of pixels per unit distance. For a calibrated (e.g., undistorted) image, one can write:

$${}^{i} P = {𝒜}_{cal} ◦ ℱ ( Φ ) \qquad ( 2 )$$

in which [symbol] _{cal} (.) is known after calibration. Assuming both [symbol] _{cal} and [symbol] are invertible, the generic backward formulation will be given as:

$$Φ = {ℱ}^{- 1} ◦ {𝒜}_{cal}^{- 1} ( {}^{i} P ) \qquad ( 3 )$$

Thus, if the inverse of functions [symbol] _{cal} and [symbol] exist, one can obtain the ray angles based on the projected point coordinates ⁱP.

### Radially Symmetric Camera Models: Forward and Backward Formulations

For radially symmetric camera model, the single-view-point mapping function [symbol] (Φ) could be further simplified to:

$$ℱ ( Φ ) = r ( θ ) [ \begin{matrix}cos ( φ ) \\ sin ( φ )\end{matrix} ] \qquad ( 4 )$$

In other words, the distance of the projected point to the center of the image coordinate system (radius) only depends on angle θ. Using (3) and (4):

$${r ( θ ) = ‖ {𝒜}_{cal}^{- 1} {(}^{i} P ) ‖}_{2} \qquad ( 5 )$$

$$[ \begin{matrix}cos ( φ ) \\ sin ( φ )\end{matrix} ] = \frac{{𝒜}_{cal}^{- 1} {(}^{i} P )}{{‖ {𝒜}_{cal}^{- 1} {(}^{i} P ) ‖}_{2}} \qquad ( 6 )$$

One can directly obtain angle φ, by solving equation (6) using the atan2(.) function. However, obtaining θ from equation (5) could be more challenging. For a radially symmetric camera, the generic r(θ) is given by:

$$r ( θ ) = {k}_{1} θ + {k}_{2} {θ}^{3} + {k}_{3} {θ}^{5} + {k}_{4} {θ}^{7} + {k}_{5} {θ}^{9} + … \qquad ( 7 )$$

where parameters kᵢ are obtained by calibration, such that (7) will be a monotonically increasing function of θ. Thus, for each pixel ⁱP, there will be only one solution θ that satisfies equation (5). That solution is obtained by finding the real root of the polynomial (7) that lies within the camera's field of view [0 θₘₐₓ].

### Simplified Radially Symmetric Camera Models

The most-frequently used, simplified version of the radially symmetric camera model is the camera pinhole model, in which a perspective projection is presumed:

$$r ( θ ) = f tan θ \qquad ( 8 )$$

Fish-eye lenses are designed to ideally obey one of the following formulations:

$$Stereographic Projection : r ( θ ) = 2 f tan θ / 2 \qquad ( 9 )$$

$$Equidistance Projection : r ( θ ) = f θ \qquad ( 10 )$$

$$Equisolid Angle Projection : r ( θ ) = 2 f sin θ / 2 \qquad ( 11 )$$

$$Orthogonal Projection : r ( θ ) = f sin θ \qquad ( 12 )$$

Solving equation (5) to obtain θ using any of (8)-(12) is straightforward.

### Obtaining Scaled Location Using a Single Image

In this section, the scaled location for points and line segments are defined. Then the feasibility of obtaining scaled location using a single camera image is discussed. The scaled location is used in the later sections to obtain the estimated time to encounter.

### Scaled Location of a Point on a Line Segment

The scaled location of points A and B as members of the line segment AB are defined as:

$${SL}_{point} ( A , \overline{AB} ) = \frac{{}^{c} A}{{‖ \overline{AB} ‖}_{2}} , {SL}_{point} ( B , \overline{AB} ) = \frac{{}^{c} B}{{‖ \overline{AB} ‖}_{2}} \qquad ( 13 )$$

where ^{c}A and ^{c}B are the locations of points A and B with respect to the camera coordinate system, and ∥A̅B̅∥₂ is the length of the line segment A̅B̅. Note that a point might have infinite scaled locations as it could be part of infinite line segments.

### Derivative of Scaled Location of a Point on a Line Segment

If the length of the line segment ∥A̅B̅∥₂ remain constant over time, then:

$$\frac{d}{dt} {SL}_{point} ( A , \overline{AB} ) = \frac{{}^{c} \dot{A}}{{‖ \overline{AB} ‖}_{2}} , \frac{d}{dt} {SL}_{point} ( B , \overline{AB} ) = \frac{{}^{c} \dot{B}}{{‖ \overline{AB} ‖}_{2}} \qquad ( 14 )$$

### Scaled Location of a Line Segment

The scaled location of line segment A̅B̅ or SLₗᵢₙₑ(A̅B̅) is a set of the scaled locations of all the points that lie on it:

$${SL}_{line} ( \overline{AB} ) = \{ \frac{α . {}^{c} B + ( 1 - α ) . {}^{c} A}{{‖ \overline{AB} ‖}_{2}} α ∈ [ \begin{matrix}0 & 1\end{matrix} ] \} \qquad ( 15 )$$

Both SLₚₒᵢₙₜ(A, A̅B̅) and SLₚₒᵢₙₜ(B, A̅B̅) are members of the set of SLₗᵢₙₑ(A̅B̅):

$${SL}_{point} ( A , \overline{AB} ) , {SL}_{point} ( B , \overline{AB} ) ϵ {SL}_{line} ( \overline{AB} ) \qquad ( 16 )$$

Also, note that one can rewrite the set (15) as:

$$SL ( \overline{AB} ) = \{ α . {SL}_{point} ( B , \overline{AB} ) + ( 1 - α ) . {SL}_{point} ( A , \overline{AB} ) α ∈ [ \begin{matrix}0 & 1\end{matrix} ] \} \qquad ( 17 )$$

In other words, the scaled locations of the endpoints of a line segment define the scaled location of that line segment.

### Finding the Scaled Location of a Line Segment Using a Single Image

Assume that A′ and B′ are the corresponding image points of A and B. Knowing the pixel coordinates of A′ and B′ and using a backward formulation similar to ones introduced in section 2, the vectors Φ_{A}=[θ_{A} φ_{A}] and Φ_{B}=[θ_{B} Φ_{B}] will be obtained. These vectors represent the direction of the rays coming from source points A and B respectively. To obtain the scaled location of a line segment using a single image, the assumption that the direction vector of the line segment A̅B̅ is known is included. The feasibility of this assumption will be further discussed in the next sections. Considering this assumption and that Φ_{A} and Φ_{B} are known, the direction of all sides of the triangle ΔBOA are known. Those directions were defined to be unit vectors ^{c}ν_{OA}, ^{c}ν_{OB}, and ^{c}ν_{AB}. The angles of this triangle were obtained as follows:

$${α}_{A} = atan 2 ( - {}^{c} {v}_{AB} \times {}^{c} {v}_{OA} , - {}^{c} {v}_{AB} \cdot {}^{c} {v}_{OA} ) \qquad ( 18 )$$

$${α}_{B} = atan 2 ( {}^{c} {v}_{AB} \times {}^{c} {v}_{OB} , - {}^{c} {v}_{AB} \cdot {}^{c} {v}_{OB} ) \qquad ( 19 )$$

$${α}_{O} = atan 2 ( {}^{c} {v}_{OA} \times {}^{c} {v}_{OB} , - {}^{c} {v}_{OA} \cdot {}^{c} {v}_{OB} ) \qquad ( 20 )$$

The law of sines for the triangle ΔBOA can be written as:

$$\frac{sin ( {α}_{A} )}{{‖ \overline{OB} ‖}_{2}} = \frac{sin ( {α}_{B} )}{{‖ \overline{OA} ‖}_{2}} = \frac{sin ( {α}_{O} )}{{‖ \overline{AB} ‖}_{2}} \qquad ( 21 )$$

The direction vectors were used to obtain the scaled location of points A and B for line segment A̅B̅:

$${SL}_{point} ( A , \overline{AB} ) = \frac{‖ \overline{OA} ‖ {{}_{2}}^{c} {v}_{OA}}{{‖ \overline{AB} ‖}_{2}} = \frac{sin ( {α}_{B} )}{sin ( {α}_{O} )} {}^{c} {v}_{OA} \qquad ( 22 )$$

$${SL}_{point} ( B , \overline{AB} ) = \frac{‖ \overline{OB} ‖ {{}_{2}}^{c} {v}_{OB}}{{‖ \overline{AB} ‖}_{2}} = \frac{sin ( {α}_{B} )}{sin ( {α}_{O} )} {}^{c} {v}_{OB} \qquad ( 23 )$$

Having the scaled location of the endpoints and using (16), the scaled location of the line segment was found.

### Scaled Location is All You Need for Estimated Time To Encounter Estimation

The scaled location defined in the previous section has two features that make it suitable for estimation of the estimated time to encounter. The first feature is that under certain conditions, the dynamic model governing the scaled location of a point is the same as the one that governs the original non-scaled location. The second feature is that the estimated time to encounter is the scaled location divided by the derivate of scaled location, e.g., the scaled velocity.

### Dynamics of the Scaled Location

Consider x to be the original state vector that describes the motion dynamics of point X with respect to the camera coordinate system. It includes the position and velocity of point X namely ^{c}X, ^{c}\dot{X}:

$$x = {[ \begin{matrix}{}^{c} X & {}^{C} \dot{X} & ⋯\end{matrix} ]}^{T} \qquad ( 24 )$$

Point X is part of a line segment A̅B̅ with known direction and fixed size of ∥ĀB∥₂. Assume that the model describing the motion of the point X is first degree homogeneous and autonomous:

$$\dot{x} = f ( x ) , f ( λ x ) = λ f ( x ) \qquad ( 25 )$$

Now take z=x/∥A̅B̅∥₂ to be the transformed state vector:

$$z = {[ \begin{matrix}\frac{{}^{c} X}{{‖ \overline{AB} ‖}_{2}} & \frac{{}^{c} \dot{X}}{{‖ \overline{AB} ‖}_{2}} & ⋯\end{matrix} ]}^{T} \qquad ( 26 )$$

The scaled location of point X (SLₚₒᵢₙₜ(^{c}X, A̅B̅)) and its derivative is part of the transformed state vector in (26). If f(x) is a first-degree homogeneous function, then:

$$\dot{z} = \frac{\dot{x}}{{‖ \overline{AB} ‖}_{2}} = \frac{f ( x )}{{‖ \overline{AB} ‖}_{2}} = f ( \frac{x}{{‖ \overline{AB} ‖}_{2}} ) = f ( z ) \qquad ( 27 )$$

As can be seen, (25) and (27) are similar models, except that they include different states.

### Scaled Location and Estimated Time To Encounter

A useful feature of the scaled location is that by estimating its dynamics, one can obtain the estimated time to encounter (TTC):

$${SL}_{point} ( {}^{c} X , \overline{AB} ) = \frac{{}^{c} X}{{‖ \overline{AB} ‖}_{2}} = \frac{{[ \begin{matrix}{}^{c} {X}_{x} & {}^{c} {X}_{y} & {}^{c} {X}_{z}\end{matrix} ]}^{T}}{{‖ \overline{AB} ‖}_{2}} \qquad ( 28 )$$

$$\frac{d}{dt} ( {SL}_{point} ( {}^{c} X , \overline{AB} ) ) = \frac{{}^{c} \dot{X}}{{‖ \overline{AB} ‖}_{2}} = \frac{{[ \begin{matrix}{}^{c} {\dot{X}}_{x} & {}^{c} {\dot{X}}_{y} & {}^{c} {\dot{X}}_{z}\end{matrix} ]}^{T}}{{‖ \overline{AB} ‖}_{2}} \qquad ( 29 )$$

$${TTC}_{x , y , z} = \frac{{}^{c} {X}_{x , y , z}}{{‖ \overline{AB} ‖}_{2}} / \frac{{}^{c} {\dot{X}}_{x , y , z}}{{‖ \overline{AB} ‖}_{2}} \qquad ( 30 )$$

A number of implementations have been described. Nevertheless, it will be understood that various modifications may be made without departing from the spirit and scope of the invention. Accordingly, other implementations are within the scope of the following claims.

What is claimed is:

1. A method of determining an estimated time to encounter using a monocular camera, comprising:
receiving image data from a camera;
identifying an object from the image data;
calculating a scaled distance between the object and a region of interest based on the image data; and
calculating a scaled velocity based on the scaled distance;
calculating an estimated time from encounter until the object will encounter the region of interest based on the scaled distance and the scaled velocity.

2. The method of claim 1, wherein the camera is mounted to a vehicle, a user, a work zone, a road hazard, or a road information indicator and the region of interest contains the camera, the vehicle, the user, the work zone, the road hazard, or the road information indicator.

3. The method of claim 1, wherein calculating the estimated time from encounter uses a ratio of the scaled distance to the scaled velocity.

4. The method of claim 1, wherein identifying the object from the image data comprises using a computer vision algorithm.

5. The method of claim 1, comprising comparing the estimated time from encounter to an encounter time threshold and, if the estimated time from encounter is less than the encounter time threshold, indicating a predicted encounter.

6. The method of claim 1, wherein determining the scaled distance comprises determining an image height of the object using the image data.

7. The method of claim 6, wherein determining the scaled distance utilizes a neural network, or a camera model which includes one or more camera properties comprising a focal length.

8. The method of claim 6, wherein determining the scaled distance comprises determining a first scaled distance in a first dimension and a second scaled distance in a second dimension.

9. The method of claim 8, wherein the first scaled distance is determined using a different method than the second scaled distance.

10. The method of claim 8, wherein calculating the scaled velocity comprises determining a derivative of the scaled distance.

11. The method of claim 10, wherein determining the derivative of the scaled distance comprises using a state observer algorithm, a neural network, a vehicle model, or numerical differentiation.

12. The method of claim 8, wherein determining the scaled distance comprises applying a correction factor and an offset correction factor to the scaled distance to determine a corrected scaled distance.

13. The method of claim 8, wherein calculating the estimated time from encounter comprises calculating a first estimated time from encounter in the first dimension and a second estimated time from encounter in the second dimension.

14. The method of claim 13, wherein calculating the first estimated time from encounter comprises calculating a ratio between the first scaled distance and a first scaled velocity and calculating the second estimated time from encounter comprises calculating a ratio between the second scaled distance and a second scaled velocity.

15. The method of claim 14, comprising comparing the first estimated time from encounter to a first encounter threshold or the second estimated time from encounter to a second encounter threshold, and, if the first estimated time from encounter is less than the first encounter threshold or the second estimated time from encounter is less than the second encounter threshold, indicating an predicted encounter.

16. The method of claim 15, wherein indicating the predicted encounter comprises displaying, on a display and for viewing by a user, a predicted encounter notification.

17. A system for determining an estimated time to encounter using a monocular camera, comprising:
a camera; and
a controller, comprising a processor and a non-transitory storage medium storing instructions that when executed by the processor cause the controller to:
receive image data from a camera;
identify an object from the image;
calculate a scaled distance between the object and a region of interest based on the image; and
calculate a scaled velocity based on the scaled distance;
calculate an estimated time from encounter until the object will encounter the region of interest based on the scaled distance and the scaled velocity.

18. The system of claim 17, wherein the object is identified using a computer vision algorithm.

19. The system of claim 17, wherein camera is mounted to a vehicle, a road hazard, a road safety indicator, or a road information indicator and the region of interest contains the camera, the vehicle, the user, the work zone, the road hazard, or the road information indicator.

20. The system of claim 17, comprising a notification system, and the controller configured to compare the estimated time from encounter to an encounter threshold and, if the estimated time from encounter is less than an encounter threshold, command the notification system to produce a notification indicative of the estimated time from encounter being lower than the encounter threshold.
